(19) United States
(12) Patent Application Publication
(10) Pub. No.: US 2005/0275603 A1
(43) Pub. Date: Dec. 15, 2005

(54) Display apparatus and display system using the same

(76) Inventor: Jong-won Park, Suwon-si (KR)

Correspondence Address: STANZIONE & KIM, LLP, 919 18TH STREET, N.W., SUITE 440, WASHINGTON, DC, 20006, US

(21) Appl. No.: 11/142,325

(22) Filed: Jun. 2, 2005

(30) Foreign Application Priority Data
Jun. 14, 2004 (KR) 2004-43724

(51) Int. Cl. G09G 5/00

(52) U.S. Cl. 345/1.1; 345/502

(57) ABSTRACT

A display system having a computer including a computer network module accessing to a network for data communication, a data storage to store multimedia data and a computer controller to transmit the multimedia data stored in the data storage through the computer network module; and a display apparatus including a display to display an image thereon, a display network module connected to the computer network module through the network and to receive the multimedia data, a multimedia data converter to convert the multimedia data into a video signal to be processed by the display, and a display controller to control the display to display the image using the video signal converted by the multimedia data converter. With this configuration, a display apparatus and a display system using the same to connect a plurality of display apparatus using a network is provided.

### CROSS-REFERENCE TO RELATED APPLICATIONS

This application claims the benefit of Korean Patent Application No. 2004-43724, filed on Jun. 14, 2004, in the Korean Intellectual Property Office, the disclosure of which is incorporated herein by reference.

### BACKGROUND OF THE INVENTION

1. Field of the Invention

The present general inventive concept relates to a display apparatus and a display system using the same, and more particularly, to a display apparatus and a display system using the same to connect a single computer with a plurality of display apparatuses using a network.

2. Description of the Related Art

Generally, a display apparatus such as a liquid crystal display (LCD) and a plasma display panel (PDP), etc., is applied to various applications, for example a television or a computer monitor, to display an image thereon.

A monitor and a computer are connected each other through a D-Sub connector or a digital visual interface (DVI) connector to transmit a video signal from the computer to the monitor therethrough. Further, the monitor separately comprises an S-Video connector, which is a component connector or a composite connector to receive the video signal from an external device such as a DVD player or a VCR.

The computer used to support only one output connecter tends to support more than two output connectors such as the D-Sub connector, the DVI connector or the S-video connector. Accordingly, more than two monitors can be connected to one computer.

Meanwhile, the computer and the monitor become able to transmit and receive not only the video signal but also data. For instance, the monitor transmits all relevant information about itself to the computer through a VESA (Video Electronics Standard Association) data display channel (DDC) communication line, and the computer regularly transmits a control signal to the monitor through the DDC communication line.

However, a conventional computer has a limited number of output connectors allowed to be installed thereto due to a limited space of the computer, and the limited number of output connectors allows only a corresponding number of monitors to be connected thereto.

Accordingly, a multi-connector is used to extend a cable to connect a plurality of connectors to access a plurality of monitors or display the same image on the plurality of monitors respectively connected to one computer through the plurality of connectors.

However, if the plurality of monitors is connected using this method, the extended cable needs to be arranged neatly and causes a loss of video signals or deterioration of a picture quality due to noise.

### SUMMARY OF THE INVENTION

Accordingly, the present general inventive concept provides a display apparatus and a display system using the same to connect a sigle computer with a plurality of display apparatuses using a network.

In addition, the computer transmits a control signal to control an operational state of the display apparatus through the network, and accordingly, the computer directly controls the display apparatus through the network.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a display system comprising a computer comprising a computer network module to access a network for data communication, a data storage to store multimedia data and a computer controller to transmit the multimedia data stored in the data storage through the computer network module; and a display apparatus comprising a display to display an image thereon, a display network module connected to the computer network module through the network and to receive the multimedia data, a multimedia data converter to convert the multimedia data into a video signal to be processed by the display, and a display controller to control the display to display the image using the video signal converted by the multimedia data converter.

The display apparatus may further comprise an audio output part to output sound, and the multimedia data converter may comprise a data sorting part to sort the multimedia data into video data and audio data; a video converter to convert the video data into the video signal; and an audio converter to convert the audio data into an audio signal to be outputted through the audio output part.

The computer controller may transmit a control signal to the display apparatus through the computer network module to control an operational state of the display apparatus, and the display controller may control a displaying state of the image displayed on the display and/or a volume level of the sound outputted to the audio output part on the basis of the control signal transmitted through the display network module.

The computer controller can detect a data type of the multimedia data, and transmit a corresponding control signal based on the detected data type of the multimedia data.

The computer controller can detect the data type of the multimedia data by a file extension of the multimedia data.

The display apparatus can further comprise a memory to store information about the operational state of the display apparatus, the display controller can transmit the information about the operational state stored in the memory to the computer through the display network module, and the computer controller can output the control signal based on the information about the operational state transmitted through the computer network.

The information about the operational state may comprise at least one of a current displaying state of the image displayed on the display and a current volume level of the audio output part.

The foregoing and/or other aspects and advantages of the present general inventive concept are also achieved by providing a display apparatus comprising a display to display an image thereon; a display network module to access a network and transmit/receive data; a multimedia data converter to convert multimedia data into a video signal to be processed by the display; and a display controller to control the display to display the image using the video signal converted by the multimedia data converter.

The display controller can detect a given control signal in the data transmitted through the display network module, and control a displaying state of the image displayed on the display according to the detected control signal.

The display apparatus may further comprise an audio output part to output sound, and the multimedia data converter may comprise a data sorting part to sort the multimedia data into video data and audio data; a video converter to convert the video data into the video signal; an audio converter to convert the audio data into an audio signal to be outputted through the audio output part.

The display controller can detect a given control signal in the data transmitted through the display network module, and control a volume level of the sound outputted to the audio output part according to the detected control signal.

### BRIEF DESCRIPTION OF THE DRAWINGS

The above and/or other aspects and advantages of the present general inventive concept will become apparent and more readily appreciated from the following description of the embodiments, taken in conjunction with the accompany drawings of which:

FIG. 1 is a control block diagram illustrating a configuration of a display system according to an embodiment of the present general inventive concept;

FIG. 2 is a control block diagram of a display system according to an embodiment of the present general inventive concept;

FIG. 3 is a control block diagram of a display apparatus according to another embodiment of the present general inventive concept; and

FIG. 4 is a control block diagram of a computer according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout.

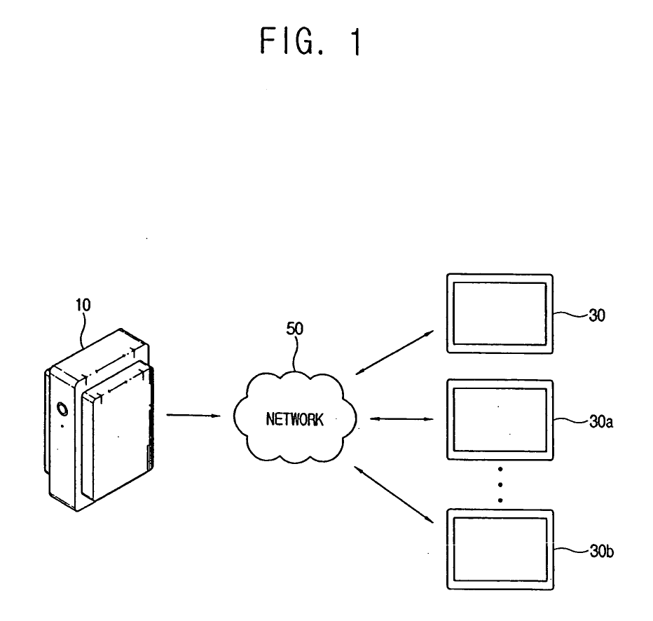

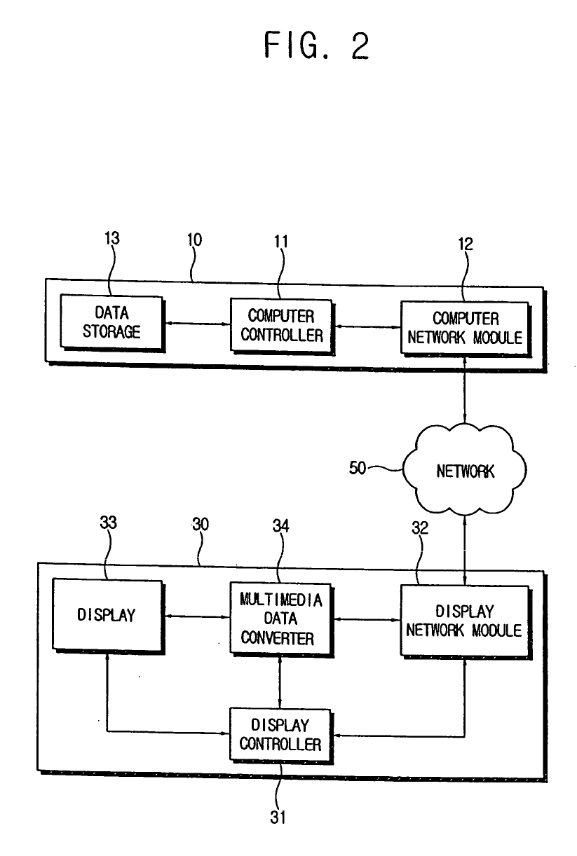

As shown in FIGS. 1 and 2, a display system according to an embodiment of the present general inventive concept comprises a computer 10 connected to a network 50, and at least one display apparatus 30 connected to the computer 10 through the network 50.

The computer 10 according to FIGS. 1 and 2 transmits multimedia data to the display apparatus 30 through the network 50. The display apparatus 30 receives the multimedia data transmitted through the network 50 to output an image or sound.

Herein, the computer 10 and the display apparatus 30 can communicate with each other through the network 50 such as a local area network (LAN), and transmits/receives data between each other using a standard communication protocol.

Referring to FIG. 2, the computer 10 comprises a computer network module 12 to access the network 50 to perform data communication; a data storage 13 to store the multimedia data; and a computer controller 11 to transmit the multimedia data stored in the storage 13 through the network module 12. Herein, the multimedia data may include various playback data, such as a moving picture file, an image file or a music file.

The display apparatus 30 comprises a display 33 to display an image thereon, a display network module 32, a multimedia data converter 34 and a display controller 31.

The display network module 32 transmits/receives data using the same standard communication protocol applied to the computer network module 12 of the computer 10, and receives the multimedia data transmitted from the computer 10 through the network 50. Herein, the display network module 32 transmits/receives the data using a TCP/IP communication protocol, and has its own IP address. Thus, the computer 10 can transmit the multimedia data to the IP address of the display apparatus 30 connected to the network 50.

The multimedia data converter 34 converts the multimedia data transmitted through the display network module 32 into a video signal so that the display 33 can process the video signal. Herein, the display controller 31 controls the display 33 to display an image using the video signal converted by the multimedia data converter 34.

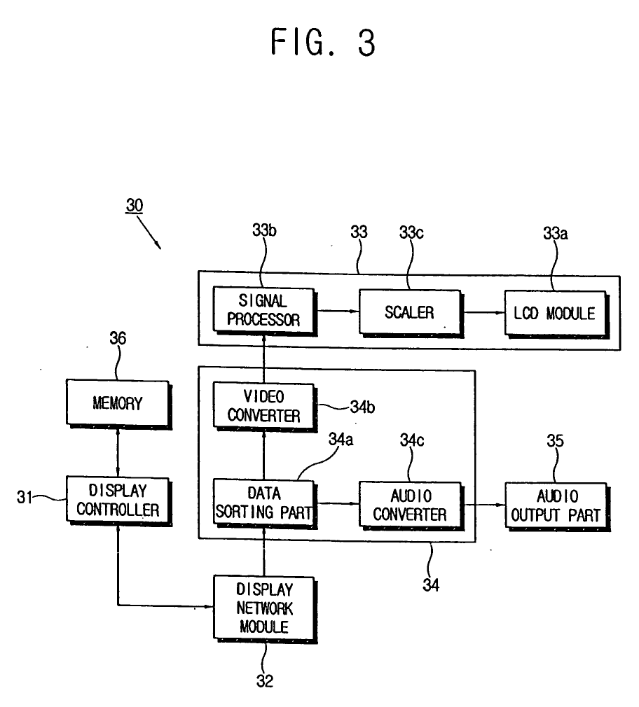

A display apparatus 30 according to an embodiment of the present general inventive concept will be described hereinafter, while referring to FIG. 3. As previously described, the display apparatus 30 comprises the display 33, the multimedia data converter 34, the display network module 32, and the display controller 31. Additionally, the display apparatus 30 may further comprise an audio output part 35 to output sound.

The display 33 according to the embodiment of FIG. 3 is illustrated as using a liquid crystal display (LCD) module, but alternatively may use various other types of display modules, such as a digital light processing (DLP) display module, a plasma display panel (PDP) display module, and the like.

The display 33 comprises an LCD module 33a to display an image thereon, a scaler 33c to perform a scaling function, and a signal processor 33b converting a video signal in various formats into a video signal to be processed by the scaler 33c.

Herein, a configuration of the display 33 may be changed depending on a format type of the video signal converted by the multimedia data converter 34. For instance, if the multimedia data converter 34 converts the video signal into an analog RGB signal, the signal processor 33b may comprise an A/D (Analog/Digital) converter to convert the analog RGB signal into a digital RGB signal and output the digital RGB signal to the scaler 33c.

Further, if the multimedia data converter 34 outputs a digital RGB signal, it can be directly outputted to the scaler 33c. In this case, the signal processor 33b may not be a necessary component of the display 33.

If the multimedia data converter 34 outputs the video signal in a low voltage differential signaling (LVDS) format, it can be directly outputted to the LCD module 33a. In this case, the display 33 may not need the signal processor 33b and the scaler 33c.

The display controller 31 controls the display 33 to adjust a displaying state of the image displayed on the display 33 according to predetermined parameters for resolution, brightness, and contrast.

The multimedia data converter 34 according to the embodiment of FIG. 3 may comprise a data sorting part 34a, a video converter 34b and an audio converter 34c.

The data sorting part 34a sorts the multimedia data transmitted through the display network module 32 into video data and audio data, and outputs the video data and the audio data to the video converter 34b and the audio converter 34c, respectively. The video converter 34b converts the video data from the data sorting part 34a into the video signal of the format to be processed by the display 33. In other words, the video converter 34b decodes the video data sorted by the data sorting part 34a, converts the decoded video data into the processable video signal and outputs it to the display 33.

The video converter 34b supports a MPEG-2 (Motion Picture Experts Group-2) decoding function to decode the video data coded using an MPEG-2 standard so as to output the video signal in a MPEG-2 format. Further, the video converter 34b may decode the video data coded using a JPEG (Joint Photographic Experts Group) standard, or other video coding standards.

In addition, the video converter 34b may output the video signal in various formats depending on configurational aspects of the display 33 as described hereinbefore. For example, the video converter 34b supports an LVDS encoding function to encode the decoded video signal into a LVDS video signal using the LVDS encoding, and output the LDVS video signal to the LCD module 33a. The video converter 34b also outputs the analog RGB signal or the digital RGB signal, and these signals are respectively outputted to the signal processor 33b and the scaler 33c of the display 33.

The audio converter 34c according to the embodiment of FIG. 3 decodes the audio data sorted by the data sorting part 34a. For instance, the audio converter 34c decodes the audio data into the MPEG-2 format, or into an AC-3 (Audio Code-3) format. Herein, if the audio output part 35 is a speaker, the audio converter 34c preferably supports a D/A conversion function converting the decoded audio signal into an analog audio signal to output the analog audio signal to the speaker.

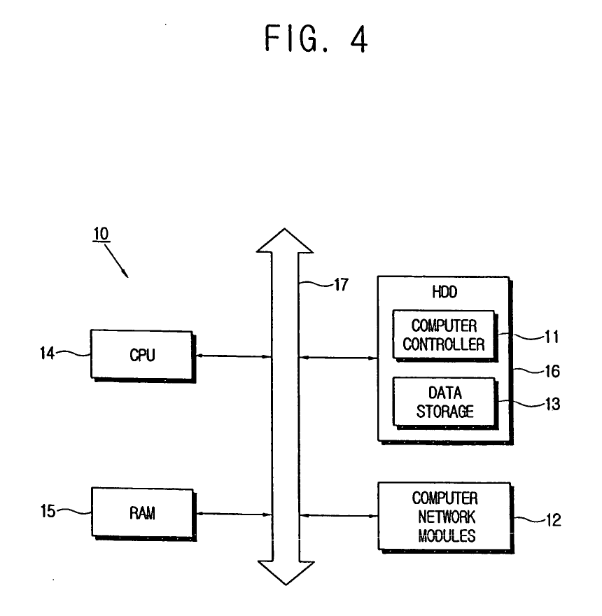

Hereinafter, a computer 10 according to another embodiment of the present general inventive concept will be described, while referring to FIG. 4.

As shown in FIG. 4, the computer 10 according to the present embodiment comprises a central processing unit (CPU) 14, a random access memory (RAM) 15 as a main memory, a hard disk drive (HDD) 16, the computer network module 12 and a system bus 17 connecting these components of the computer 10.

An example of the data storage 13 in this embodiment is the HDD 16. Herein, the data storage 13 may comprise an external storage such as a memory stick connected to the computer 10, or any kind of device which is capable of storing the multimedia data.

The computer controller 11 according to the embodiment of FIG. 4 can comprise, for example, an application program executed based on an operating system of the computer 10. Accordingly, the computer controller 11 may be installed and stored in the HDD 16.

The computer controller 11 is loaded into the RAM 15 to be run when a user executes the computer controller 11. Herein, the computer controller 11 transmits the multimedia data to the display 30 through the computer network module 12.

Further, the computer controller 11 may transmit a control signal to the display apparatus 30 through the computer network module 12 to control an operational state of the display apparatus 30. In this case, the display controller 31 controls the operational state of the display apparatus 30 according to the control signal transmitted through the display network module 32.

For example, the computer controller 11 transmits the control signal to the display 33 of the display apparatus 30 through the network 50 to control a displaying state of an image displayed thereon. In other words, the computer controller 11 transmits the control signal to the display apparatus 30 through the computer network module 12 to control resolution, brightness and contrast of the image displayed on the display 33. Also the display controller 31 adjusts the resolution, brightness and contrast of the image displayed on the display 33 in accordance with the received control signal. Thus, the user directly controls the displaying state of the images displayed on the displays 33 of plural display apparatuses 30 connected to the computer 10 by the network 50.

Herein, the computer controller 11 detects a data type of the multimedia data transmitted through the computer network module 12, and transmits an appropriate control signal in accordance with the detected data type of the multimedia. For example, if a moving picture file as the multimedia data is transmitted to the display apparatus 30, the computer controller 11 may transmit a predetermined control signal with appropriate levels of resolution, brightness and contrast to display a moving picture. Herein, the computer controller 11 detects the type of the multimedia data by a file extension of the multimedia data.

In addition, the computer controller 11 according to the present embodiment may transmit the control signal to control a volume level of the sound outputted through the audio output part 35 to the display apparatus 30 through the computer network module 12. In this case, the display controller 31 controls the volume level of the sound outputted to the audio output part 35 according to the control signal transmitted to the computer 10.

Meanwhile, referring back to FIG. 3, the display apparatus 30 according to the embodiment of FIG. 3 may comprise a memory 36 to store information about the operational state of the display apparatus 30. The information about the operational state of the display apparatus 30 may include information about a current displaying state of the image displayed on the display 33, and a current volume level of the sound outputted to the audio output part 35. Herein, the display controller 31 transmits the information about the operational state stored in the memory 36 to the computer 10 through the display network module 32.

Here, the computer controller 11 outputs the control signal on the basis of the information about the operational state transmitted through the network 50. For example, the computer controller 11 transmits a control signal through the network 50 to appropriately control the volume level of the data type of the multimedia data on the basis of the information about the current volume level of the sound outputted to the audio output part 35 of the display apparatus 30. Further, the computer controller 11 generates a control signal to display the image on the display 33 in the best displaying state based on the information about the current display state of the display 33 and the data type of the multimedia data.

According to the foregoing embodiments, the control signal transmitted to the display apparatus 30 from the computer 10 is described as an example to control the displaying state of the image and/or the volume level of the sound. Further, the computer controller 11 may output a control signal to control various functions of the display apparatus 30 such as turning on/off power of the display apparatus 30.

As described, the computer 10 comprises the computer network module 12 to access through the network 50 for data communication, the data storage 13 to store the multimedia data and the computer controller 11 to transmit the multimedia data stored in the data storage 13 to the display apparatus 30 through the computer network module 12, and the display apparatus 30 comprises the display 33 to display the image thereon, the display network module 32 connected to the computer network module 12 and to receive the multimedia data, the multimedia data converter 34 to convert the multimedia data into the video signal to be processed by the display 33, and the display controller 31 to control the display 33 to display the video signal converted by the multimedia data converter 34. With this configuration, the plurality of display apparatuses 30 can be connected to the computer 10 using the network 50.

Further, the computer controller 11 transmits the control signal to the display apparatus 30 to control the operational state of the display apparatus 30 through the computer network module 12, and thereby directly adjust the displaying state of the image or the volume level of the sound from the computer 10.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A display system comprising:
a computer comprising a computer network module to access a network for data communication, a data storage to store multimedia data and a computer controller to transmit the multimedia data stored in the data storage through the computer network module; and
a display apparatus comprising a display to display an image thereon, a display network module connected to the computer network module through the network and to receive the multimedia data, a multimedia data converter to convert the multimedia data into a video signal to be processed by the display, and a display controller to control the display to display the image using the video signal.

2. The display system according to claim 1, wherein the display apparatus further comprises an audio output part to output sound, and
the multimedia data converter comprises a data sorting part to sort the multimedia data into video data and audio data; a video converter to convert the video data into the video signal; and an audio converter to convert the audio data into an audio signal to be outputted through the audio output part.

3. The display system according to claim 2, wherein the computer controller transmits a control signal to the display apparatus through the computer network module to control an operational state of the display apparatus, and the display controller controls a displaying state of the image displayed on the display and/or a volume level of the sound outputted to the audio output part on the basis of the control signal transmitted through the display network module.

4. The display system according to claim 3, wherein the computer controller detects a data type of the multimedia data, and transmits a corresponding control signal based on the detected data type of the multimedia data.

5. The display system according to claim 4, wherein the computer controller detects the data type of the multimedia data by a file extension of the multimedia data.

6. The display system according to claim 4, wherein the display apparatus further comprises a memory to store information about the operational state of the display apparatus,
the display controller transmits the information about the operational state stored in the memory to the computer through the display network module, and the computer controller outputs the control signal based on the information about the operational state transmitted through the computer display network module.

7. The display system according to claim 6, wherein the information about the operational state comprises at least one of a current displaying state of the image displayed on the display and a current volume level of the audio output part.

8. A display apparatus comprising:
a display to display an image thereon;
a display network module to access a network and to transmit/receive data;
a multimedia data converter to convert received multimedia data into a video signal to be processed by the display; and
a display controller to control the display to display the image using the video signal converted by the multimedia data converter.

9. The display apparatus according to claim 8, wherein the display controller detects a given control signal in the data transmitted through the display network module, and controls a displaying state of the image displayed on the display according to the detected control signal.

10. The display apparatus according to claim 8, further comprising an audio output part to output a sound, and
the multimedia data converter comprising a data sorting part to sort the multimedia data into video data and audio data; a video converter to convert the video data into the video signal; an audio converter to convert the audio data into an audio signal to be output through the audio output part.

11. The display apparatus according to claim 10, wherein the display controller detects a given control signal in the data transmitted through the display network module, and controls a volume level of the sound outputted to the audio output part according to the detected control signal.

12. A display system comprising:
a computer comprising:
a network communication part to communicate data to and from a network,
a storage unit to store multimedia data, and
a controller unit to transmit the stored multimedia data through the network communication part; and
a display apparatus comprising:
a display unit to display an image,
a display network module to receive the multimedia data from the network communication part, and
a display controller to control conversion of the multimedia data into a video signal and to control the displaying of the image by the display unit using the converted video signal.

13. The display system according to claim 12, wherein the display controller controls conversion of the multimedia data into video data to be outputted through the display unit and audio data to be outputted as sound.

14. The display system according to claim 13, wherein the display apparatus further comprises an audio output part to output the audio data as sound.

15. The display system according to claim 14, wherein the controller unit transmits a control signal to each of the display apparatus through the network communication part to control an operational state of each display apparatus, and the respective display controller controls a displaying state of the image displayed on the respective display unit and/or a volume level of the sound outputted to the respective audio output part on the basis of the control signal transmitted through the display network module.

16. The display system according to claim 15, wherein the controller unit detects a data type of the multimedia data, and transmits a corresponding control signal based on the detected data type of the multimedia data.

17. The display system according to claim 16, wherein the display apparatus further comprises a memory to store information about the operational state of the display apparatus, and the display controller transmits the information about the operational state stored in the memory to the computer through the display network module, and the controller unit outputs the control signal based on the information about the operational state transmitted through the display network module.

18. A method of displaying multimedia data on a display apparatus using a network, the method comprising:
transmitting the multimedia data from a central location through a network; and
receiving the multimedia data at the display apparatus, converting the multimedia data into a video signal to be processed by each of the display apparatus, and controlling the display of an image at each of the display apparatus using the converted video signal.

19. The method according to claim 18, wherein the converting of the multimedia data comprises:
sorting the multimedia data into video data and audio data;
converting the video data into the video signal to be displayed; and
converting the audio data into an audio signal to be output as sound.

20. The method according to claim 19, further comprising transmitting a control signal to each of the display apparatus through the network from the central location, to control an operational state of each of the display apparatus, controlling the displaying state of the image displayed on each of the display apparatus and/or a volume level of the sound outputted on the basis of the control signal transmitted through the network.

21. The method according to claim 20, wherein the operation of transmitting a control signal comprises detecting a data type of the multimedia data, and transmitting a corresponding control signal based on the detected data type of the multimedia data.

22. The method according to claim 20, wherein the control signal transmitted is based on information received through the network about an operational state of the display apparatus.
